(19) United States
(12) Patent Application Publication
(10) Pub. No.: US 2020/0216297 A1
(43) Pub. Date: Jul. 9, 2020

(54) An improved turntable

(71) Applicant: O.ME.R. S.p.A., Mirano (IT)

(72) Inventor: Orietta Rossato, Mirano (IT)

(21) Appl. No.: 16/468,393

(22) PCT Filed: Sep. 6, 2017
(86) PCT No.: PCT/IB2017/055360

§ 371 Date: Jun. 11, 2019

(30) Foreign Application Priority Data
Sep. 6, 2016 (IT) 102016000090068
Dec. 19, 2016 (IT) 102016000128162

(51) Int. Cl. B66F 7/28; G01B 5/255

(52) U.S. Cl. CPC B66F 7/28; G01B 2210/10; G01B 5/255

(57) ABSTRACT

An improved turntable, adapted to detect, correct and/or adjust wheel alignment of a vehicle, includes a fixed base to be positioned on a surface; a movable assembly, mounted onto the fixed base so as to rotate and translate with respect thereto and having an upper plate that receives and supports a wheel and a lower disk integral with the upper plate; a locking mechanism associated with the fixed base, which interacts with the lower disk of the movable assembly; an actuator that causes the locking mechanism to pass from a first condition, in which the mechanism limits and counters translations of the lower disk in a lying plane while allowing rotations of the disk about an axis perpendicular to the lying plane, to a second condition, in which the mechanism allows free translations of the lower disk in its lying plane and free rotations of the disk about such axis.

The present invention relates to an improved turntable to be used for detecting, correcting and/or adjusting the alignment of the wheels of a motor vehicle.

Systems for adjusting the alignment of the wheels of a vehicle are particularly important because an incorrect alignment may cause an excessive or non-homogeneous wear of the wheels, and it may also cause problems in driving and in the stability of the vehicle. In particular, the systems are configured to adjust one or more characteristic angles of the wheels, for example the convergence angle, the incident angle and the tilting angle, in order to check the alignment of the wheels themselves and to possibly intervene to correct it.

In order to adjust the alignment of the wheels, each of these is to be correctly positioned on a device called a turntable and generally comprising a plate or table which is rotating with respect to a fixed bearing structure, which usually is conveniently installed on the lanes of a lift.

In order to allow the wheel to be put and correctly positioned on the turntable, there is a need for the latter to be locked with respect to the fixed structure; when the wheel has been positioned on the turntable, the latter is to be released so that the wheels and the related suspensions may be positioned freely on the turntable, thus being arranged in a position with no friction preloads.

Currently, the locking and releasing operation of the turntable is manually performed using suitable locking pins. It is easy to infer how this is not completely satisfactory because the manual insertion and removal of the pins is a rather laborious, difficult and inconvenient operation.

Other turntables of known type, such as for example that of US 2005/0133309, instead provide the total locking both of the rotation and the translation of the turntable with respect to the fixed structure below. Such a solution creates undesired preload circumstances during the step of the wheel being put and positioned on the turntable, associated with the fact that the wheel may not rotate or be freely rotated on the turntable to correct the positioning thereof with respect to the fixed structure below; in particular, such a correction at times is required to perform and/or optimize the calibration operations of the instruments for checking the alignment.

In particular, during the step of putting and positioning the wheel on the upper base, the solution of US 2005/0133309 limits and locks the rotation of the assembly formed by the lower disk and by said upper disk. In greater detail, such a rotation is prevented by the friction forces which develop between the rectilinear side edge of the engagement levers and the peripheral edge of the lower disk and to this end, US 2005/0133309 recommends inserting engagement teeth at the contact portions of the levers with the lower disk so as to increase the friction and therefore the locking in rotation of the assembly formed by the lower disk and the upper base intended to receive and support the wheel.

Moreover, the solution of US 2005/0133309 describes a rather complicated solution in terms of construction, which requires the presence of a suitable annular disk which is controlled in rotation by an actuator and which is provided with a plurality of gaps, each of which defines a specific cam profile in order to cause a suitable movement of the levers which engage the outer edge of the lower disk, which is integral with the upward base intended to receive and support the wheel.

US US2005/0133309 also describes a device which comprises an intermediate structure for allowing a regular transfer of the wheel onto the operating plate of the turntable itself. In particular, this intermediate structure comprises a bar which is vertically movable between a raised position in which the upper surface thereof is coplanar with that of the operating plate of the turntable, and a lowered position in which the upper surface thereof is parallel, but at a lower height, with respect to that of the operating plate of the turntable itself. Such a solution is not completely satisfactory because it is rather complicated in terms of construction and moreover, the bar shape does not ensure a gradual and continuous passage of the wheel onto the operating plate of the turntable.

It is an object of the invention to provide an improved turntable which overcomes the drawbacks of traditional turntables.

It is another object of the invention to provide a turntable which does not require any manual intervention by the operator at the wheel of the vehicle intended to be put and positioned on the turntable itself.

It is another object of the invention to provide an improved turntable which does not require any manual intervention by the operator at the wheel of the vehicle.

It is another object of the invention to provide a turntable which, during the step of putting and positioning the wheel on the turntable itself, limits the longitudinal and transverse movements thereof.

It is another object of the invention to provide a turntable which, during the step of putting and positioning the wheel on the turntable itself, avoids creating preloading circumstances.

It is another object of the invention to provide a turntable which allows as gradual and continuous a passage/transfer of the wheel as possible on/onto the upper plate of the turntable.

It is another object of the invention to provide a turntable which is simple and easy to be used and also is remote-controlled.

It is another object of the invention to provide a turntable which may be easily mounted to the lanes of traditional motor vehicle lifts.

It is another object of the invention to provide a turntable which allows the automatic centering of the movable components thereof.

It is another object of the invention to provide a turntable which has an alternative characterization with respect to traditional ones, both in construction and functional terms.

It is another object of the invention to provide a turntable which can be made in a simple and quick manner and with low costs.

All these objects, both individually and in any combination thereof, and others which will become apparent from the description below, are achieved according to the invention, with an improved turntable having the features indicated in claims 1 to 3.

The present invention is hereinbelow further clarified in a preferred embodiment thereof, which is described by mere way of non-limiting example, with reference to the accompanying drawings, in which:

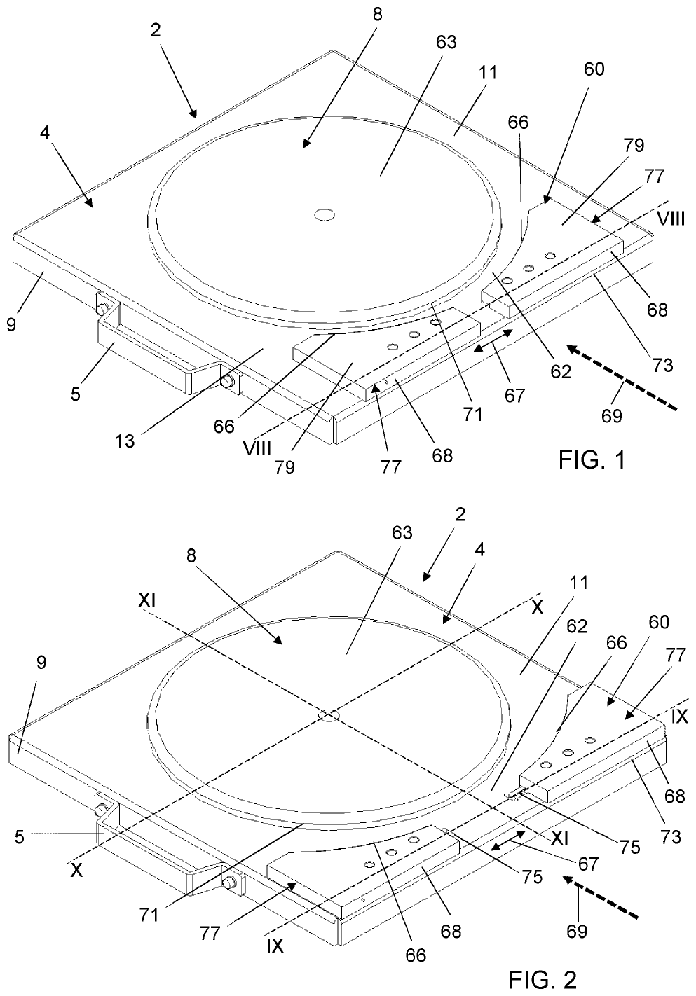

FIG. 1 shows a top perspective view of a turntable according to the invention, in which the device for facilitating the transfer of the wheel is in a first operating condition,

FIG. 2 shows it in the same view of FIG. 1, with said device in a second operating condition,

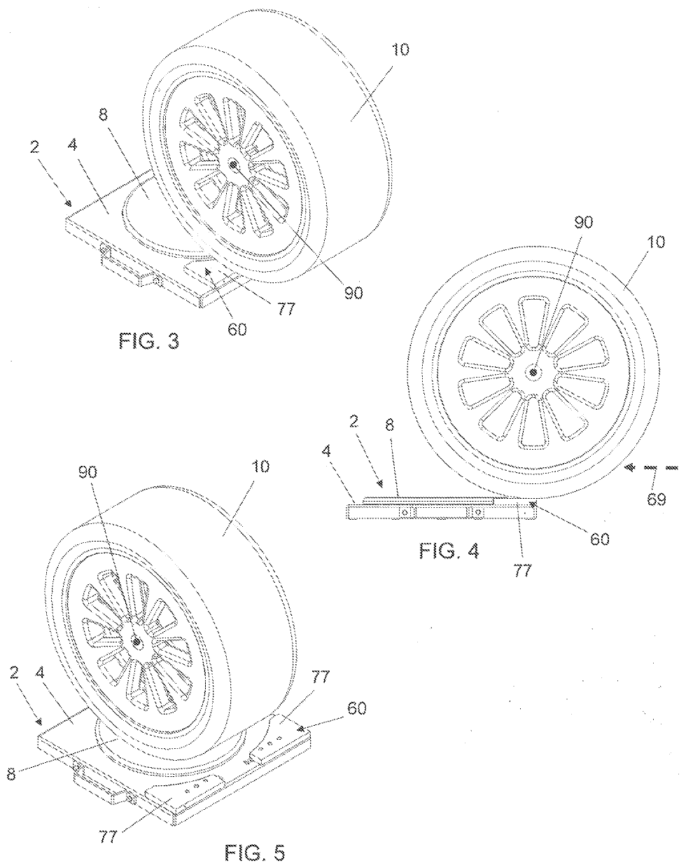

FIG. 3 shows a perspective view of the wheel passing onto the turntable according to the invention,

FIG. 4 shows a side view of the wheel passing onto the turntable according to the invention,

FIG. 5 shows a perspective view of the wheel positioned on the turntable according to the invention,

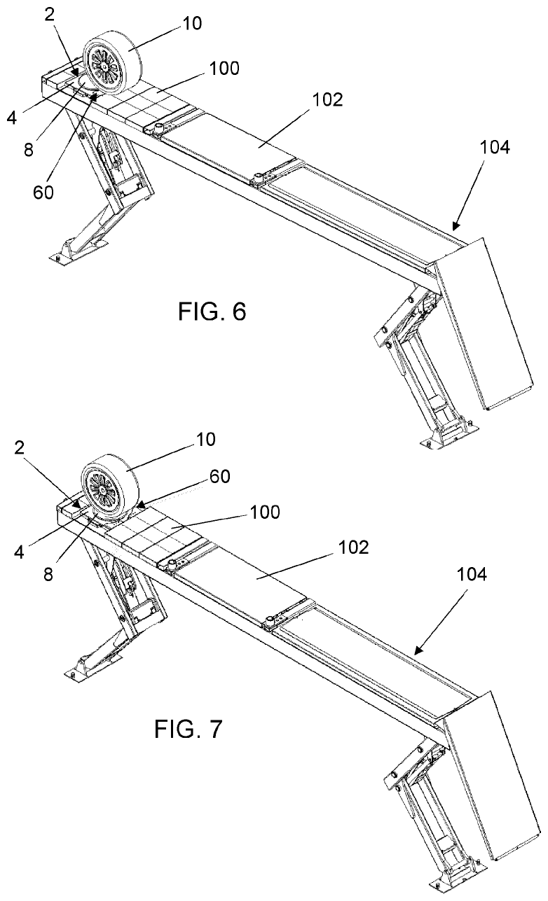

FIG. 6 shows a perspective view of the wheel passing onto the turntable according to the invention, installed on a lane of a motor vehicle lift,

FIG. 7 shows a perspective view of the wheel when it is positioned on the turntable according to the invention, installed on a lane of a motor vehicle lift,

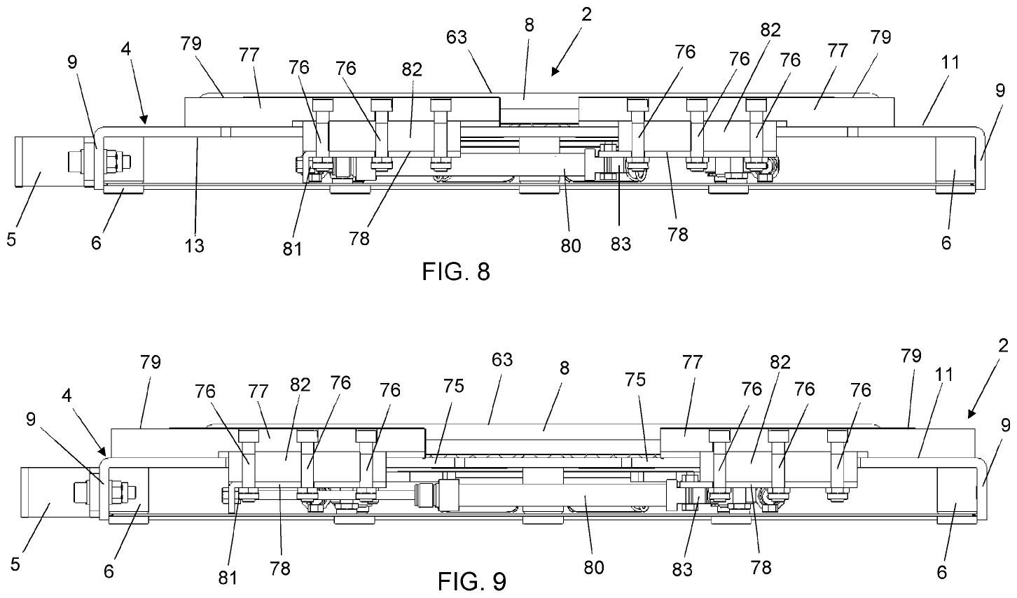

FIG. 8 shows the turntable according to the invention, according to the vertical section passing through axis VIII-VIII of FIG. 1,

FIG. 9 shows it according to the vertical section passing through axis IX-IX of FIG. 2,

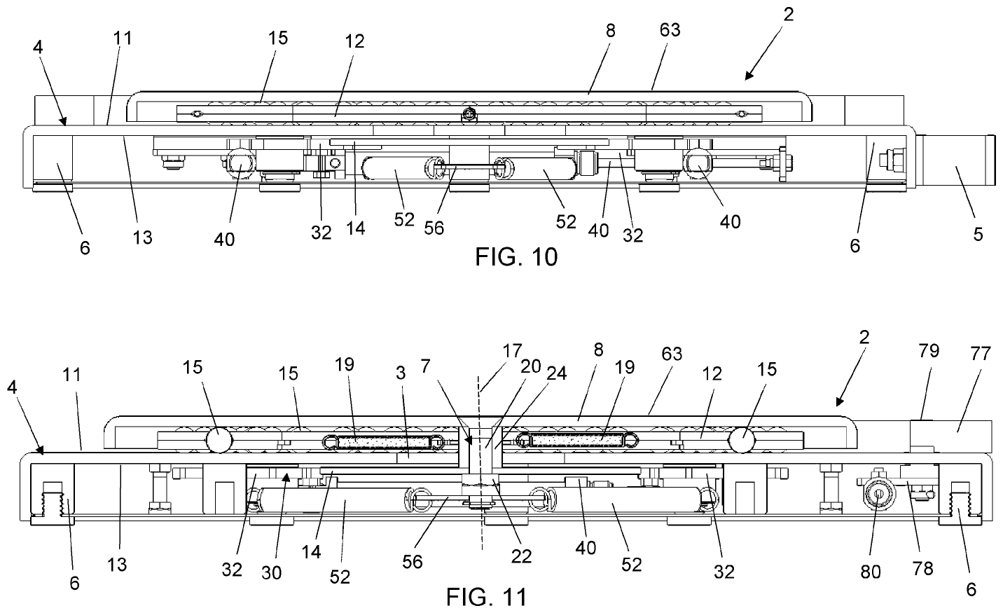

FIG. 10 shows it according to the vertical section passing through axis X-X of FIG. 2, and

FIG. 11 shows it according to the vertical section passing through axis XI-XI of FIG. 2,

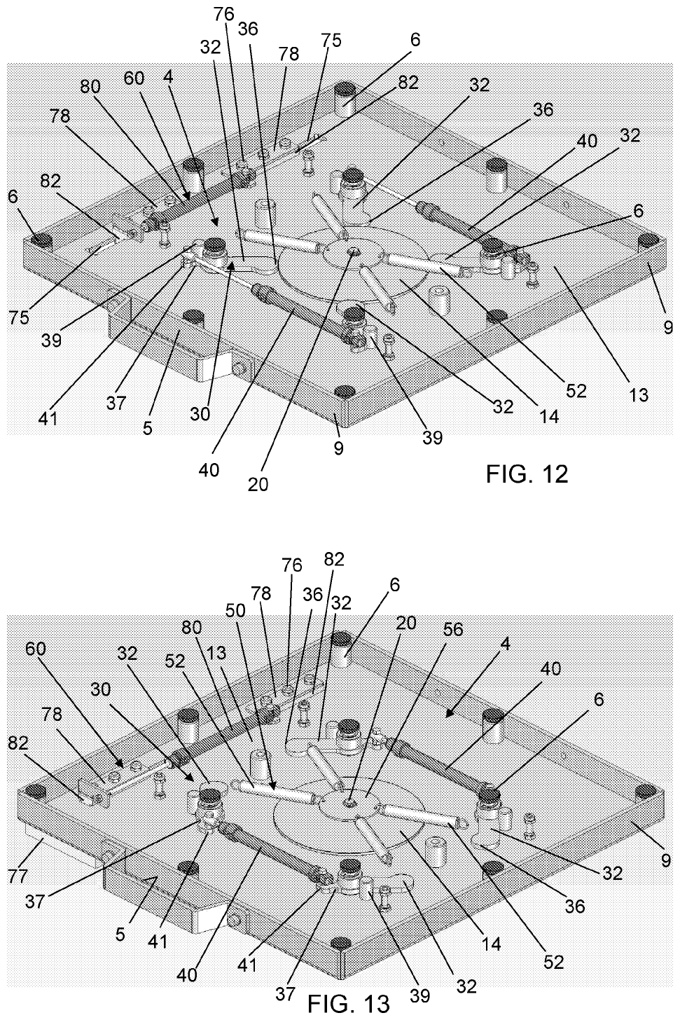

FIG. 12 shows a bottom perspective view thereof, in a condition of locked turntable, and

FIG. 13 shows a bottom perspective view thereof, in a condition of released turntable.

As shown by the drawings, the improved turntable 2 according to the invention, to be used for detecting, correcting and/or adjusting the alignment of the wheels of a motor vehicle, comprises a fixed base 4 provided with a through opening 3 which is preferably circular in shape and is made in the middle of the base itself.

Preferably, the fixed base 4 is provided with a handle 5 to facilitate the gripping and moving of turntable 2 by the operator. Advantageously, the fixed base 4 comprises a plurality of spacers (feet) 6 and side laths 9, applied thereto and intended to laterally close the space delimited by the lower surface 13 of the fixed base 4 and by a supporting surface below, which may consist of the floor of the workshop or of a portion of a lane of a lift on which turntable 2 is conveniently installed.

Turntable 2 also comprises a movable assembly 7 which is associated with and mounted to the fixed base 4 so as to allow the movement in rotation thereof and the translation with respect thereto.

The movable assembly 7 comprises an upper plate 8 intended to receive wheel 10 of the vehicle. Preferably, plate 8 has a middle through hole and is disk-shaped, but it could also have the shape of a polygon, e.g. of a quadrilateral.

The movable assembly 7 also comprises a lower element 14 which is conveniently disk-shaped and which is integral with the upper plate 8. Conveniently, the lower disk 14 has a middle through hole which is aligned along a vertical axis 17 with the middle hole of the upper plate 8. Conveniently, the diameter of the lower disk 14 is greater than that of the through opening 3 of the fixed base 4 so as to prevent the release of the lower disk 14 and the lifting of the upper plate 8.

In particular, the lower disk 14 is restrained to the upper plate 8 by means of a screw 20 which, after crossing the through holes of both, is then conveniently held by means of a self-locking nut 22. It is also provided for the upper plate 8 and the lower disk 14 to be conveniently made in a single piece.

The through opening 3 is closed at the top by plate 8 and at the bottom by disk 14. In particular, the upper plate 8, intended to receive wheel 10 of the vehicle, is positioned above the upper surface 11 of base 4, while the lower disk 14 is positioned below the lower surface 13 of base 4.

Advantageously, a preferably annular-shaped intermediate body 12 provided with sliding means which preferably consist of a plurality of ball bearings 15, is interposed between the lower surface of the upper plate 8 and the upper surface 11 of base 4. Conveniently, the intermediate body 12 with the ball bearings 15 support the rotating upper plate 8 and simultaneously reduce the friction resulting from the rotation and/or movement of the upper plate 8 of the movable assembly 7 with respect to the fixed base 4.

Preferably, there are associated, with the annular intermediate body 12, means 19 for keeping it centered with respect to axis 17. In particular, these means comprise springs or other elastic members 19 which connect the intermediate body 12 to a tubular bushing 24, which body is crossed by screw 20 and therefore is integral with the upper plate 8.

Turntable 2 also comprises a locking mechanism 30 mounted to the fixed base 4 and prepared to selectively interact with the lower disk 14 of the movable assembly 7. In particular, mechanism 30 comprises at least two, preferably four, engagement levers 32 which substantially are coplanar with the lower disk 14 and are arranged about the latter in diametrically opposite two-by-two positions. Moreover, each engagement lever 32 is articulated about a corresponding rotation pin with which the engagement lever 32 is associated. Preferably, the rotation pin consists of the spacer foot 6 of the fixed base 4.

Turntable 2 also comprises at least one actuator 40 for causing said mechanism 30 to pass from a first condition (working), in which it limits and counters the translation of the lower disk 14 in its lying plane while allowing the rotation of the lower plate 14 about an axis 17 thereof perpendicular to said lying plane, to a second condition (resting), in which it allows the free translation of the lower plate 14 in the lying plane thereof and the free rotation of the plate itself about said axis 17.

Conveniently, each engagement lever 32 is directly associated with the end of an actuator 40 without requiring any intermediate element. In particular, each engagement lever 32 is directly associated with an actuator 40 at an end 41 which is opposite to end 36 cooperating with the outer edge of said lower disk 14.

Advantageously, the end 36 of each lever 32 interacting with the lower plate 14 is shaped so as to avoid it from jamming therewith, when it is actuated. In particular, to this end, the end 36 of each lever 32 cooperating with the outer edge of the lower disk 14 is substantially beveled, and preferably has an at least partially rounded and/or circular profile. Advantageously, in order to avoid jamming, the end 36 of each lever 32 may be provided with a rotating element (not shown), e.g. a roller, a wheel or a bearing, so as to reduce the frictions resulting from the contact and sliding thereof with the edge of the lower plate 14.

Advantageously, the locking mechanism 30 comprises stroke end or abutment elements 39 for locking the further rotation of each engagement lever 32 about the articulation pin 6 thereof when passing from the first to the second condition of said locking mechanism, or vice versa. Conveniently, the abutment elements 39 are configured and arranged so that when all the engagement levers 32 reach and counter said abutment elements 39 in said first condition of said locking mechanism 30, any translation of the lower disk 14 in the lying plane thereof is substantially limited or prevented.

In particular, each lever 32 comprises a side portion 37 shaped so as to interact with a corresponding abutment element 39 associated with the fixed base 4 both in said first condition (the working one, see FIG. 12) and in said second condition (the resting one, see FIG. 13). In particular, in working condition, the contact of the side portion 37 of each lever 32 with the abutment element 39 allows a situation to be created in which the end 36 of said levers 32 locks the lower plate 14 so as to prevent the opening thereof (i.e., the lateral movement thereof) and also to prevent loading actuator 40 with the forces resulting from the wheel of the vehicle being put onto the upper plate 8 when the movable assembly 7, to which the lower plate 14 belongs, is subjected to pushes in the advancement direction of the wheel of the vehicle. Instead, in resting condition, the contact of the side portion 37 of each lever 32 with the abutment element 39 substantially defines a stroke end for the extension of actuator 40.

Advantageously, the articulation portion of each engagement lever 32 for pin 6 associated with the fixed base 4 is interposed between end 41 associated with actuator 40 and end 36 cooperating with the outer edge of said lower disk 14. Conveniently, the side portion 37 of lever 32 which is shaped to interact with the abutment elements 39 is interposed between the ends 36 or 41 of the lever itself and the articulation portion of each lever 32 for pin 6 of the fixed base 4.

Preferably, there are provided two actuators 40, each of which is coupled to a pair of adjacent levers 32, at end 41 opposite to end 36. In particular, each actuator 40 is configured to move the corresponding lever 32, or pair of levers 32, to which it is coupled, between said first condition (the working one), in which the end 36 of each lever 32 is substantially in contact or is particularly close to the edge of the inner disk 14 (see FIG. 12), and said second condition (the resting one), in which the end 36 of each lever 32 is spaced apart from the edge of the lower disk 14 (see FIG. 13) as long as the side portion 37 thereof is in contact with the abutment element 39. Conveniently, it is understood that in resting condition, the end 36 of each lever 32 is further spaced apart from the edge of the inner disk 14 with respect to the working condition.

In greater detail, in working condition, the lower disk 14 and the upper plate 8 integral therewith (i.e. the whole movable assembly 7) are free to rotate about the vertical middle axis 17 thereof, while by countering with the edge of the lower disk 14, the engagement levers 32 limit and/or prevent the translation of the movable assembly 7 with respect to the fixed base 4.

In resting condition instead, the lower disk 14 and the upper plate 8 integral therewith (i.e., the whole movable assembly 7) are free to rotate and also to translate with respect to the fixed base 4. Conveniently, the movement of the movable assembly 7 is limited by the possible contact between the tubular bushing 24 and the inner edge of the through opening 3 of the fixed base 4.

Conveniently, when passing from the resting condition to the working condition, the action of the engagement levers 32 returns the lower disk 14, and therefore the movable assembly 7, to a predetermined and preferred position with respect to the fixed base 4. Preferably, such a predetermined preferred position, which is then that reached in the working condition of the engagement levers 32, corresponds to a situation in which axis 17 of the movable assembly 7 passes through the middle of the through opening 3 of the fixed base 4.

Advantageously, actuator 40 is a pneumatic, electric or a hydraulic linear cylinder, which is movable between an extended configuration, which corresponds to the working condition of the engagement levers 32 (see FIG. 12), and a retracted configuration, which corresponds to the resting condition of the engagement levers 32 (see FIG. 13).

Advantageously, actuator 40 may be controlled by acting on a suitable dedicated switch or on a control interface (not shown), which are associated, in easily accessible position, with the turntable or with the lift in which turntable 2 is installed. Preferably, actuator 40 may be controlled remotely by means of a control interface connected via cable or wirelessly to turntable 2.

Advantageously, turntable 2 also comprises means 50 for returning the movable assembly 7 to a predetermined preferred position with respect to the fixed base 4, which preferably corresponds to the condition in which axis 14 of the movable assembly 7 passes through the middle of the through opening 3 of the fixed base 4.

In particular, these means 50 comprise elastic members 52, which connect assembly 7, and particular the lower disk 14 thereof, with the fixed base 4, and which are configured and arranged to keep and return such an assembly in/to a specific position with respect to the fixed base 4. Conveniently, the elastic members 52 are configured so that the corresponding elastic forces are null when assembly 7 is in the middle of the through opening 3 of the fixed base 4.

In greater detail, the elastic members 52 comprise at least two pairs of springs which are associated, two-by-two and in diametrically opposite position, with the fixed base 4 and with a body 56 which is integral with assembly 7. Conveniently, body 56 comprises a disk or collar which is restrained to the lower disk 14 or which is conveniently fitted about the end of screw 20 which holds together the upper plate 8 and the lower disk 14.

Conveniently, the presence of elastic means 50 ensures the lower disk 14 is automatically brought to a position, preferably in the middle of the fixed base 4, such as to allow the engagement levers 32 to counter the disk itself with the edge thereof when they are brought to the working condition.

The operation of turntable 2 according to the invention is as follows. Firstly, actuator 40 is controlled so as to bring the engagement levers 32 to working condition. Conveniently, the levers 32 push the lower disk 14, which is integral with the upper plate 8, so as to bring the movable assembly 7 defined thereby towards a preferably centered, predetermined desired position with respect to the fixed base 4.

Then wheel 10 is put on the upper plate 8 of plate 2 (see FIG. 3) and this causes a movement on the plate itself, which causes the contact of the edge of the lower disk 14, which is integral with said plate, with the engagement levers 32. In greater detail, the latter prevent the translation of the lower disk 14 in the lying plane thereof, while the disk itself remains free to rotate about axis 17. Advantageously, this allows the movable assembly 7 to be adapted to wheel 10 which is raised, thus avoiding the creation of preloading circumstances.

Once wheel 10 of the vehicle is completely on the upper plate 8 (see FIG. 5), the activation of the actuators 40 is controlled so that the levers 32 are spaced apart from the lower disk 14 and are brought to the resting condition. Thereby, the upper plate 8, which is integral with the lower disk 14, is therefore free to translate in all directions of the lying plane thereof according to the stresses impressed by the wheels so as to adjust the alignment of the wheels and make any corrections.

Conveniently, the slightly beveled shape of the end 36 of the engagement levers 32 allows a reciprocal sliding thereof with respect to the edge of the lower disk 14 so as to also facilitate the passage from the working condition to the resting condition thereof.

Turntable 2 also comprises an improved device 60 for facilitating the transfer/positioning of wheel 10 onto the upper plate 8 of the turntable itself. Conveniently, device 60 is configured to vary the free space 62 about the upper plate 8, which free space comprises both the upper surface 11 of base 4 and the areas 100 (defined by the application context of the plate itself) which are outside said base 4 and adjacent thereto.

In particular, device 60 comprises two plates 77 which laterally slide towards and from each other. In greater detail, the plates 77 are slidably movable along a transverse direction 67 which is perpendicular to the advancement direction 69 of wheel 10 in order to allow the suitable positioning and complete resting thereof on the upper plate 8 of the movable assembly 7.

Conveniently, each sliding plate 77 has a profile 66 which is at least partially complementary to the profile of the upper plate 8, at the side facing the upper portion. Advantageously, profile 66 is conveniently curved, preferably defined by one or more arcs of circumference or substantially curved profiles, and is preferably complementary to the circular profile 71 of the upper plate 8.

Advantageously, the sliding plate 77 also has an outer profile 68 which is substantially rectilinear and is preferably substantially flush with the edge 73 of base 4 which is intended to be crossed by wheel 10 in order to be positioned on the upper plate 8.

Device 60 also comprises its own actuator 80 for causing the sliding plates 77 to pass from a first position (see FIG. 1), in which such plates are close to one another, preferably they are in contact (or almost) with one another, along said transverse direction 67, to a second position (see FIG. 2), in which the plates 77 are mutually further spaced apart along the transverse direction 67.

Conveniently, in said first position (see FIG. 1), the sliding plates 77 are closer to one another and to the upper plate 8 so as to allow the transfer/positioning of wheel 10 onto the upper plate, while in said second operating position (see FIG. 2), the sliding plates 77 are further apart from one another than with respect to the upper plate 8 so as to thus allow the free movement of the latter according to the stresses impressed by the wheel once it has been positioned/transferred on/onto the plate itself.

In device 60 according to the invention, the upper surface 79 of each sliding plate 77 always remains substantially coplanar with the upper surface 63 of the upper plate 8. In other words, the surfaces 79 and 63 are coplanar both when the sliding plates 77 are close to one another (i.e. in said first operating position) and when they are spaced further apart from one another (i.e. in said second operating position). Conveniently, to this end, each sliding plate 77 has, with respect to the upper surface 11 of base 4, a height which substantially corresponds to that of the upper plate 8.

Each sliding plate 77 is mounted to a corresponding sliding guide 75. In particular, such sliding guides 75 are defined by two corresponding gaps, preferably but not necessarily aligned with each other, which are made in base 4 and which serve as guides for corresponding spacer plates 82 restrained at the bottom to the sliding plates 77 by means of a plurality of vertical pins 76. In greater detail, the pins 76 which cross the spacer plates 82 are fixed at the top to the sliding plate 77 and at the bottom to a corresponding bracket 78.

Conveniently, the spacer plates 82 have a guide surface at the bottom which is in contact with the lower surface 13 of base 4 so as to prevent the movable assembly—which is defined by the sliding plates 77 and by the spacer plates 82—from coming out of the sliding guides obtained in base 4. Moreover, such a movable assembly, which slides in the sliding guides 75 obtained in base 4, is capable of supporting the forces generated by the transfer of wheel 10 onto the upper plate 8.

Actuator 80, with the brackets 78, are positioned below the lower surface 13 of the fixed base, i.e. inside the space delimited by the latter and by a supporting surface below, which may consist of the floor of the workshop or of a portion of a lane 102 of a lift 104 on which turntable 2 is conveniently installed.

Conveniently, the two brackets 78, each of which is associated with a sliding plate 77, are fixed at the opposite ends 81, 83 of actuator 80.

Advantageously, actuator 80 is a pneumatic, electric or a hydraulic linear cylinder, which is movable between an extended configuration, which corresponds to the operating condition of mutually moving away the plates 77 (see FIG. 10), and a retracted configuration, which corresponds to the operating condition of mutually approaching of the plates 77 (see FIG. 9).

Advantageously, actuator 80 is sized and positioned so that the sliding plates 77 slide over a substantially equal distance following the extension/retraction thereof.

Advantageously, actuator 80 may be controlled by acting on a suitable dedicated switch or on a control interface (not shown), which are associated, in easily accessible position, with the turntable or with lift 104 in which turntable 2 is installed. Preferably, actuator 80 may be controlled remotely by means of a control interface connected via cable or wirelessly to turntable 2.

Advantageously, the maximum mutually spacing and approaching limit positions of the sliding plates 77 are defined by means of mechanical abutments obtained in the fixed base 4.

The operation of the device 60 of turntable 2 according to the invention is as follows. Firstly, to position wheel 10 on the upper plate 8—which conveniently is in a preferably centered, predetermined desired position with respect to the fixed base 4 and is in the condition in which it may only rotate (and not translate) about axis 17—the actuator 80 of device 60 is controlled so as to bring the sliding plates 77 to the mutually approaching operating condition and thus allow wheel 10, which advances in direction 69, to pass in a substantially regular and continuous manner from areas 100, which are adjacent but external to plate 2 itself, to the upper plate 8 (see FIG. 3).

Preferably, during this passage, the rotation axis 90 of wheel 10 substantially does not undergo any variation of level (in height) with respect to that it had before coming into contact with turntable 2. Indeed, once wheel 10 advances and comes into contact with turntable 2, it is always resting on the upper surface 79 of the sliding plates 77 and/or on the upper surface 63 of the upper plate 8 which, as mentioned, are substantially always coplanar to one another (see FIG. 4).

Conveniently, it is worth noting that when the sliding plates 77 are in the operating condition of mutual approaching, the residual space 62 has a size such as substantially not to be detected by wheel 10 when passing from the sliding plates 77 to the upper plate 8.

Preferably, when the sliding plates 77 are in the operating condition of mutual approaching, they advantageously serve as further safety for limiting and preventing the possible translation of the upper plate 8 during the step of positioning wheel 10 on the plate itself.

Therefore, once wheel 10 of the vehicle has completely passed on the upper plate 8 (see FIG. 5), in addition to controlling the activation of the actuators 40 in order to thus allow the upper plate 8 to be free to translate in all the directions of the lying plane thereof, the activation is also controlled of the actuator 80 of device 60 so as to bring the sliding plates 77 to the operating condition of mutual spacing. In particular, in such a condition, the sliding plates 77 conveniently are spaced apart from the upper plate 8 so as not to prevent or limit the translations of the latter according to the stresses impressed by wheel 10, which is positioned thereon.

Advantageously, the control of the actuators 40 of mechanism 30 for locking/releasing the movable assembly 7 is synchronized with the control of the actuator 80 of device 60.

Turntable 2 according to the invention, with or without device 60, may conveniently be installed on the lanes 102 of lifts 104 (see FIGS. 6 and 7) and may be used to support the wheels 10 of a vehicle in order to adjust the alignment thereof and to allow possible corrections.

Conveniently, in such a case, the presence of device 60 allows the transfer of wheel 10 from the intermediate area 100 of lane 102 to the operating plate 8 of turntable 2 to be made more regular and continuous. In particular, to this end, the upper surface of the area 100 of lane 102, which is adjacent to said turntable 2, the upper surface 79 of said sliding plates 77 and the upper surface 63 of said upper plate 8, are all substantially coplanar.

It is worth noting that the above-described device 60 may be used in any turntable 2, regardless of the methods provided for locking/releasing the operating plate intended to receive and support wheel 10. Moreover, it is also understood that the locking mechanism 30 of the operating plate intended to receive and support wheel 10 as described above may be used in a turntable 2 without the above-described device 60.

It is apparent form what is said that the improved turntable according to the invention is more advantageous than the traditional ones, because:
it allows the positioning (centering) and the locking of the translation of the plate intended to receive and support the wheel to be automatically performed, without therefore requiring the operator to manually intervene on the mechanical components of the turntable itself,
the fact that the movable assembly may rotate during the step of putting and positioning the wheel on the upper plate of the turntable allows the assembly itself to adapt to wheel being raised, thus avoiding the creation of preloading circumstances,
it is easy to be manufactured since it does not require an increased number of components,
the configuration of the engagement levers and of the respective stroke end elements which prevent the further rotation of said levers allows the lower disk of the movable assembly to be firmly locked, thus preventing the opening thereof when it is subjected to the pushes in the advancement direction of the wheel of the vehicle, and also allows the forces transmitted to the actuators of the locking mechanism to be reduced during the step of the wheel being put on the turntable itself,
it may be easily prepared also for being remote-controlled,
it requires limited centering forces and in particular, the locking mechanism of the levers acts by locking itself alone once the levers counter with the abutment (stroke end) elements and therefore, it does not receive the load due to the push or rotation of the wheel in the step of being put on and/or taken off of the turntable itself,
it allows a more regular and continuous transfer of the wheel onto the upper plate of the turntable.

The invention claimed is:

1.-46. (canceled)

47. A turntable, adapted to detect, correct, and/or adjust alignment of wheels of a motor vehicle, comprising:
a fixed base adapted to be positioned on a supporting surface;
a movable assembly mounted onto said fixed base so as to rotate and translate with respect thereto, said movable assembly comprising an upper plate adapted to receive and support a wheel, and a lower disk integral with said upper plate;
a locking mechanism associated with said fixed base and interacting with said lower disk of said movable assembly;
at least one actuator configured to cause said locking mechanism to pass from a first condition, in which said locking mechanism limits and counters translations of the lower disk in a lying plane thereof while allowing rotations of the lower disk itself about an axis perpendicular to said lying plane, to a second condition, in which said locking mechanism allows the translations of the lower disk in the lying plane and the rotations of the lower disk about said axis.

48. The turntable according to claim 47, further comprising a device adapted to facilitate transfer/positioning of the wheel onto said upper plate, said device comprising at least one second plate which is movable, along at least one direction parallel to an upper surface of said fixed base, between a first position in which said second plate defines a passage length for allowing the transfer/positioning of the wheel onto said upper plate, and a second position in which said second plate allows the movement of said upper plate according to stresses impressed by the wheel after the wheel has been positioned/transferred onto said upper plate.

49. A turntable adapted to detect, correct, and/or adjust alignment of wheels of a motor vehicle, comprising:
a fixed base adapted to be positioned on a supporting surface;
a movable assembly mounted onto said fixed base so as to rotate and translate with respect thereto, said movable assembly comprising an upper plate adapted to receive and support a wheel;
a device adapted to transfer/position the wheel onto said upper plate,
wherein said device comprises at least two plates which laterally slide toward and away from each other, along at least one direction parallel to the upper surface of said fixed base, between a first position in which said at least two plates define a passage length configured to allow the transfer/positioning of the wheel onto said upper plate, and a second position in which said at least two plates allow a free movement of said upper plate according to stresses impressed by the wheel after the wheel has been positioned/transferred onto said upper plate.

50. The turntable according to claim 47, wherein said locking mechanism comprises at least one pair of levers which, in said first condition, counter an edge of the lower disk and which, in said second condition, are spaced apart from the edge of the lower disk.

51. The turntable according to claim 47, wherein said locking mechanism comprises at least one pair of levers which are articulated about an articulation pin associated with said fixed base, are substantially coplanar with said lower disk, and are arranged in diametrically opposite positions with respect thereto.

52. The turntable according to claim 51, wherein said at least one pair of levers comprises two pairs of levers arranged two-by-two in diametrically opposite positions with respect to the lower disk, and wherein the turntable comprises two actuators, each of which acting on a corresponding pair of levers.

53. The turntable according to claim 47, wherein said locking mechanism comprises abutment or stroke end elements adapted to lock a rotation of each lever about the articulation pin, said abutment or stroke end elements being configured and arranged so that when all of the levers reach said abutment or stroke end elements in said first condition of said locking mechanism, any translation of the lower disk in the lying plane is limited or prevented.

54. The turntable according to claim 53, further comprising, for each lever, an abutment element shaped and positioned to interact with a portion of said lever so as to lock a rotation of said lever about the articulation pin in said first and/or said second condition.

55. The turntable according to claim 54, wherein the portion of said lever which is shaped to interact with said abutment or end stroke element is interposed:
between an articulation portion of each lever with respect to said fixed base and a portion of the lever which is associated with said at least one actuator, and/or
between the articulation portion of each lever with respect to said fixed base and a portion of the lever cooperating with an outer edge of said lower disk.

56. The turntable according to claim 49, wherein said device comprises at least two plates which slide between a closer and a more distant position with respect to said upper plate.

57. The turntable according to claim 49, wherein an upper surface of said at least two plates always remains substantially coplanar with an upper surface of the upper plate.

58. The turntable according to claim 49, wherein each one of the at least two plates comprises, at a side facing said upper plate, a profile which is, at least partially, substantially complementary to a profile of said upper plate.

59. The turntable according to claim 49, wherein each one of the at least two plates comprises an outer profile which is substantially flush with an edge of the fixed base.

60. The turntable according to claim 49, wherein said device includes an actuator that causes the at least two plates to pass from said first position, in which said at least two plates are closer both to each other and to the upper plate, to said second position, in which said at least two plates are spaced apart both from each other and from the upper plate.

61. The turntable according to claim 60, wherein said actuator comprises a linear cylinder, which is movable between an extended configuration and a retracted configuration, which correspond to two operating positions of said at least two plates.

62. The turntable according to claim 60, wherein the at least two plates are mounted onto corresponding sliding guides, which are aligned with one another and are obtained on an upper surface of said fixed base.

63. The turntable according to claim 60, wherein the at least two sliding plates are restrained to the opposite ends of said actuator, which is disposed below a lower surface of said fixed base.

64. The turntable according to claim 49, further comprising a control and command system of the actuator that facilitates the transfer/positioning of the wheel onto said upper plate.

65. The turntable according to claim 47, wherein a control for a second actuator operatively coupled to said fixed base is synchronized with the control and command system of the actuator.

66. A motor vehicle lift comprising:
at least one turntable according to claim 47, said at least one turntable being installed on at least one lane of the motor vehicle lift.
